(19) United States
(12) Patent Application Publication
(10) Pub. No.: US 2015/0228425 A1
(43) Pub. Date: Aug. 13, 2015

(54) SYSTEM FOR CONTROL OF SEVERAL ELECTRICAL APPLIANCES IN A SINGLE ROOM BY A SINGLE WALL-MOUNTED CONTROLLER

(71) Applicants: Petr KREJZA, Praha 10 (CZ); Pavel KREJZA, Praha 10 (CZ)

(72) Inventors: Petr KREJZA, Prague (CZ); Pavel KREJZA, Prague (CZ)

(21) Appl. No.: 14/433,588

(22) PCT Filed: Oct. 11, 2013
(86) PCT No.: PCT/CZ2013/000127

§ 371 Date: Apr. 3, 2015

(30) Foreign Application Priority Data
Oct. 12, 2012 (CZ) PV 2012-695

(51) Int. Cl. H01H 13/81; H01H 13/705

(52) U.S. Cl. CPC H01H 13/81; H01H 13/705; H01H 2231/016; H01H 2231/012

(57) ABSTRACT

The single-room electrical appliance multi-switch system using a single-wall mounted controller (10) being provided with a programmable multi-switch that may switch at least 3 output circuits and/or appliances controlled by at least one wall-mounted controller (10) consisting of at least a basic single-pushbutton control element with the configuration of pushbuttons I/O interconnected with performance switching elements for the switching of power circuits.

### TECHNICAL FIELD

The invention covers a system designated for the control of several electrical appliances installed in a room using a single wall-mounted controller device.

### STATE OF ART

What has been known from the practical technical applications are various solutions of the control of electrical appliances installed in a single room. The world-wide prevailing trend is focused on always more sophisticated solutions based on remote radio and infra control devices or bus bar based controllers such as KNX/EIB, DAL), OpenTherm, EnOcean, Ethernet types and many other advanced control systems.

In the past, one could live with an installed lighting fitting and wall-mounted switch and a couple of sockets—the entire electrical installation was ready. Today, the things work differently: other systems to be installed include louvers, roller shutters, fans, air-conditioning, electrical-drive-controlled garage gates, decorative lights. The user wishes to control and set his/her heating system parameters directly from the wall-mounted controller, to water his/her flowers, open roof windows, pull out canopies and use a number of other functionalities.

Should all such tasks be addressed by remote controllers and if the control of all specified appliances from any single point in the house and its environs is to be possible, one has to resolve several problems. If we skip the constantly growing density of the radio smog amidst of which users are forced to live and whose adverse impacts on human health have not been reliably disconfirmed as well as the lack of reliability due to the mutual interference, building concrete envelope transmission, one of the core issues is the position of the remote controllers so that they could be easily and repeatedly used. According to the current experience, users wish to have one extra fixed wall-mounted controller available as they search for the remote controller throughout their apartment/house on regular basis. You could object that if we decide to have a remote control system, we save distribution cables, but it is not the full truth. The costly power cables have to supply power to the appliance anyhow so the saving refers to the control cabling, only, however, it may include light current/communication cables that are cheap. Moreover, the possibility of wireless control from a distant place through a wall often involves no benefits at all.

The radio and infra remote control systems are sure to be meaningful and they will significantly improve the user's comfort in frequently repeated changes. The remote TV control system may be an example of the above. The radio remote control system makes sense, for instance, when controlling garage gates or entrance gates. To stop your car in front of the gate, go out to open the gate, move ahead, close the gate and once more the same steps in front of the garage gate is nuisance if you compare it to the RC remote control comfort when the user leaves the vehicle in his/her dry garage, only. But pulling down the window shutter, roller, canopy, turn up lights, aquarium lights, switching on heating and a lot of other operations are done once or twice a day. In this field, the sole remote control system does not make sense and we can assert that continuous search for the remote controllers, reliability, battery replacement bring rather discomfort. Therefore, it may be recommended just as a complement to a fixed wall mounted controller.

One could object that this issue could be resolved using wall-mounted RC controllers that may be relocated by the user to another position, for instance to his/her bed, but anyhow, there still will be a certain lack of reliability to be taken into account. This issue may be resolved by a fixed wire controller installed nearby the bed, for example.

Another trend includes sophisticated systems controlled by data bus bars, controllers in the form of colored touch screens or internet-controlled computers or cell phones. The internet based control and GSM gate based control systems surely make sense. The users may switch on his/her appliances or monitor the house security systems when not at home. For instance, he/she may switch on the heating system and heat up the apartment/house before he/she comes home. However, it is difficult to be excited by a wall-mounted controller designed as a small colored screen with petty icons used for switching of lights, heating, pulling down shutters, selecting various lighting scenes in particular if the user is an elderly person who has problems with the reading of the items as on the screen or a visitor who has to be trained or briefed thoroughly or be given an operational manual before the use of the system, if we leave aside the fact that such a system is still very expensive compared to what the user expects from it. Moreover, the user would have to keep in continuous contact with the programmer because the user will not be able even to switch on his/her lights in case of a failure of the smart control system. Therefore, such systems serve mostly as a tool that is supposed to amaze visitors showing the excellence and stunning functionalities of the system purchased by the user. In fact, the clients find out after some time that the costly system is just an impressive thing that will affect the required functionality in a limited extent, only. A simple controller or switch of various designs can control the lights, heating, shutters with the same effect.

Should the user draw the same conclusion as described above and if he/she selects standard simple single-purpose switches as the solution of his/her control needs, he/she will face a problem where to install all such switches if they are supposed to be provided in a larger room with a number of electrical appliances. Thus, batteries of 5 and more switches in two lines above each other are provided in sitting rooms and kitchens. Thus, the walls look rather like ugly power plant control center panels if we skip the problem that they occupy too much space needed for furniture provided the switch batteries are supposed to remain accessible. Moreover, the user will get lost in the number of switches not knowing what controls what, if we leave aside visitors. Moreover, if you need your appliances to be controlled from several points, for instance in larger lobbies or sitting rooms with several entrances, such switch control circuits have to be combined in a way for the user to have the possibility to switch every appliance on/off from every entrance point. Doing so requires lots of costly cabling to be installed in addition to the laboriousness of the installation works.

### DISCLOSURE OF INVENTION

The above-referred to deficiencies will be eliminated by a system controlling several electrical appliances installed in a room using at least one wall-mounted controller, so called multi-switch. The system is based on the fact that the wall-mounted controller consists of a basic two-push button control element with the configuration of push buttons 1/0+1/0 with at least 6 switched outputs for the appliance control.

As an alternative design, the wall-mounted controller consists of a single-push button control element with the push button configuration 1/0 for 3 switched outputs.

The wall-mounted controller may be operated In the mode of a bistable switch, pushbutton or time switches including their combination.

Wall-mounted controllers that are supposed to control electrical appliances from various points are networked by low is voltage wires and connected to a distribution board. This may be done in two alternative ways when the electronic switching element itself is located in the distribution board and power cables run out from the distribution board to individual appliances. The advantage of this design is the voltage-free feeding cable as long as the appliance is not active. Another way is the other option where the electronic switching element is located below the room controller. 12 to 24 V power supply cables are provided from the distribution board to the electronic switch and individual appliances are connected by low voltage wires with appliances being provided with performance switching elements consisting of a relay or opto-elements. They will provide for the switching of every given appliance. The advantage is a significant saving of the power cabling when several types of light fittings may be connected to a single power circuit, for instance.

Advantages of the above-proposed solution of the use of the wall-mounted controller for the multi appliance control reside in a considerable saving of cabling, easy installation that does not need to be carried out by a professional fitter. Another advantage of this solution is no need for complex programming. An essential benefit is saving of wall-mounted controllers and installation space with the use of any number of controllers whatsoever. A safe voltage level of 12-24 V may be used for premises exposed to enhanced risk of electrical shock. No cable patching and branching boxes are necessary which is another advantage. The system relies on a simple parallel jointing and, this is why any number of controllers may be used. Other substantial benefits include very easy design documentation and affordable purchasing prices.

This technical design improves proven classic functional control using controllers and push buttons lowering the number large batteries of single purpose switches by converting a single-purpose controller/switch a multi-purpose switching element.

A very easy design documentation, simple cabling, saving of controllers in particular as far as costly design is concerned and enormous variability—these are attributes associated with the concerned controller—the multi-controller/switch and, as the case may be, timer.

Thus, electronic devices are made to serve people, first of all, their control is comfortable and, first of all, they are affordable.

### CLARIFICATION OF DRAWINGS

The room multi-controller/switch as described in this invention paper will be detailed based on specific examples of design using attached drawings where

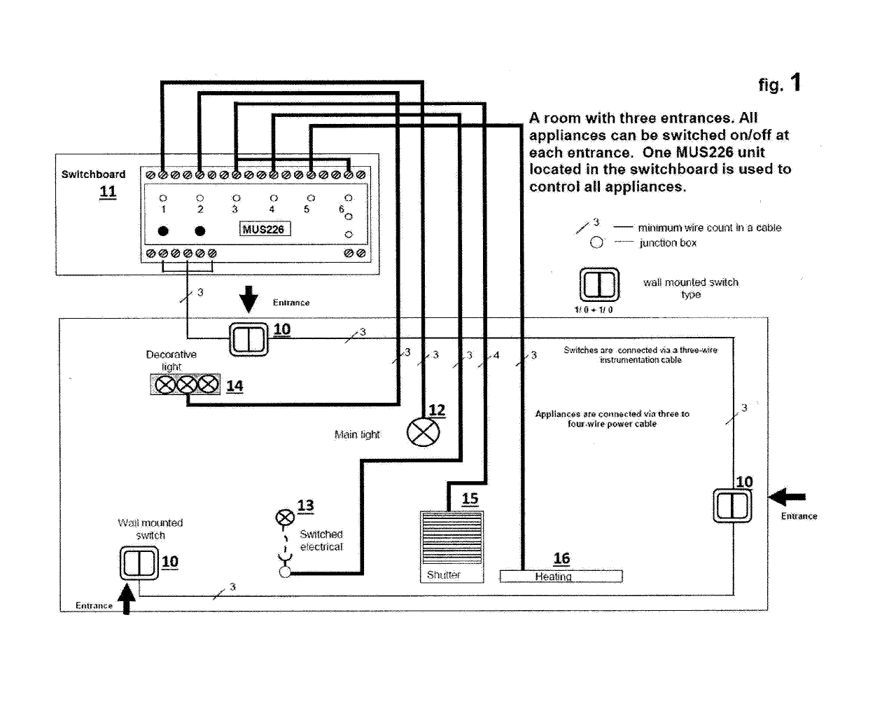

the FIG. 1 shows a model wiring diagram where individual appliances are controlled by a multi-switch installed in the distribution board.

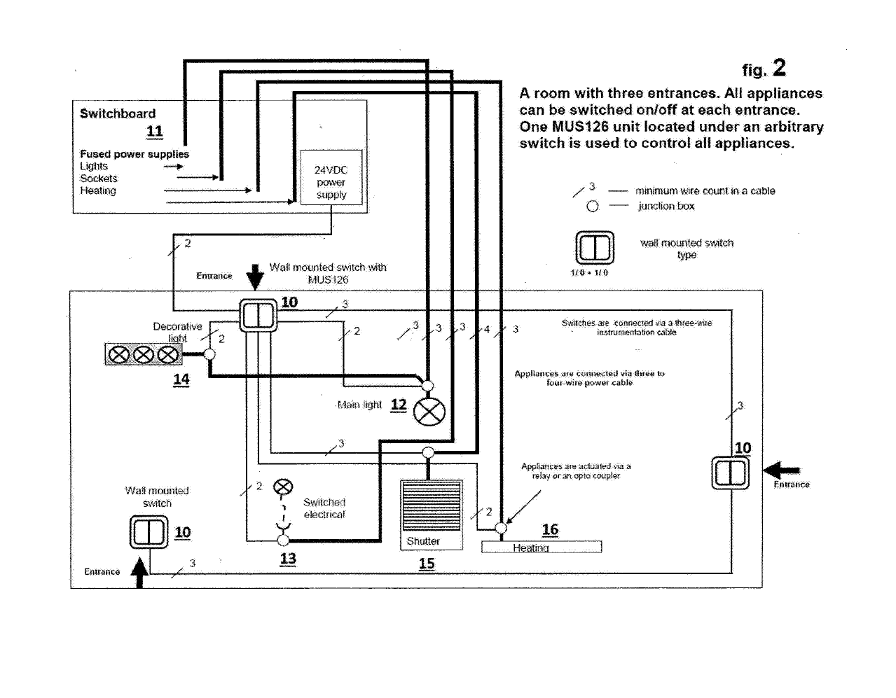

The FIG. 2 shows a wiring diagram of the control of appliances using a low-voltage multi-switch installed below one controller. For comparison,

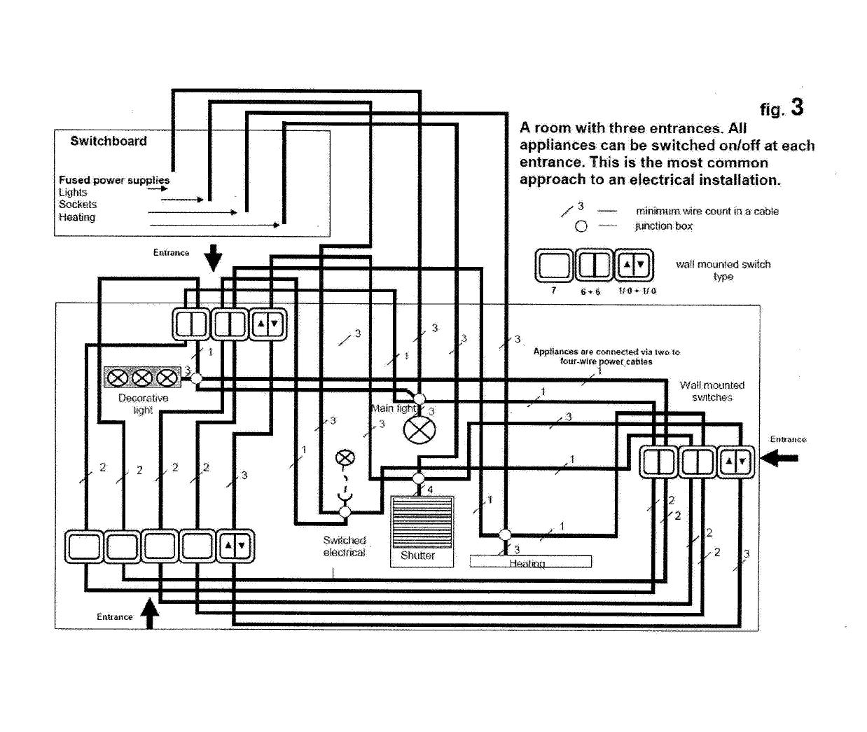

the FIG. 3 shows a standard costly installation that has to be replaced by the concerned multi-switch system.

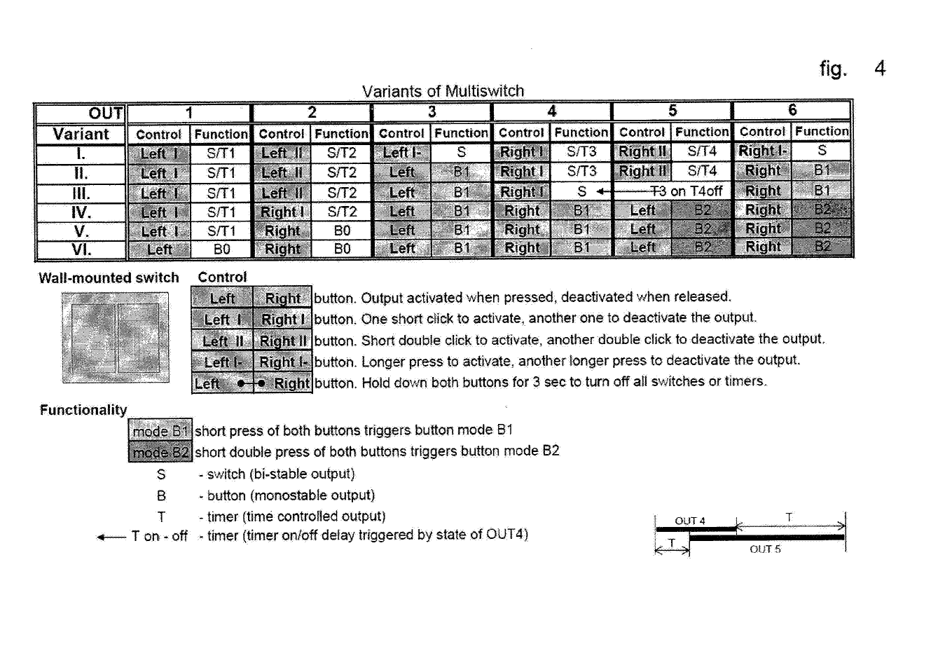

The FIG. 4 includes a table of options of the programming of the multi-switch.

### EXAMPLES OF THE INVENTION APPLICATIONS

The model multi-switch system for the control of electrical appliances installed in a single room using wall-mounted controllers 10 has all such controllers 10 made of a basic two-pushbutton control element with the push button configuration 1/0+1/0 in any design with an installation box with the depth up to 40 mm. As an option, a single-pushbutton system may be used with one half of the number of switching options that are sufficient in some cases.

No other components are necessary in the design where the multi-switch is installed in the distribution board 11 on a DIN bar except for the communication cabling from the controllers 10 and power cabling feeding appliances.

In the design where the multi-switch is installed below one of the wall-mounted controllers 10, it is necessary to provide for a 12-24 V power supply source and a switching element for the appliances in addition to the power and communication cables in the distribution board 11. The switching elements consist of relays or opto-elements.

When using the system, push button multi-strokes or a combination of both push button strokes are used but in order to avoid useless complexity of the control, the number of control outputs of a single controller 10 has been limited to maximum six outputs. That means that every push button has three outputs assigned.

Moreover, the system programming is variable and it may be used in six ways and each such an option, in addition to these six ones/offers the possibility to decide whether the switch will be a standard-controlled one or whether it will be deactivated automatically.

That means for instance that it will serve in the option 1 as a sixfold switch and controller of a louver or a double light dimmer. Another option envisages that one double controller may control three louvers independently or two louvers independently and both of them centrally. Moreover, the system may serve as a staircase light switch with an adjustable switching time or as a timer controlling the time of the switching of a WC fan, for instance.

For a detailed description of individual options of the setting of the system see the attached option table No. 4.

The advantage of the system is the fact that the system can store all last settings in its memory and reset them after a blackout. Therefore, it is not necessary to re-program the system and even not to switch the lights provided they were on before and at the moment of the blackout.

What is to be remembered are just the following control operation combinations: short stroke, two short strokes following immediately after each other, one long stroke and both push buttons stroke at the same time. That is all.

For a common control function, such as the activation of the main lighting fitting, use one short stroke as the most common operation so you do not need to explain anything to your visitors, they will switch the light automatically and naturally. For instance, the lighting fitting as above your working desk may be turned up by two short strokes and if they want to turn up the heating or light up the aquarium, they will stroke and keep pushed down the push button for longer than 0.6 second and the system output will be activated. The same may be connected to the second half. As well, the other half may be used for another room.

### EXAMPLE There is a single ceiling-mounted lighting fitting 10, one reading table lamp 13a decorative lighting system 14, one outer electrically controlled window shutter or roller 15 and an electrical heating system switch 16 in the room. As the room has three entrance points, the control system has to be provided at all three entrance doors or at two doors and the third control point may be provided for instance at the bed.

Only one controller 10 is provided at every entrance door instead of three double switches in a triple frame. The controllers 10 are interconnected by a simple light current/communication three wire cable—a Sykfy cable, UTP doorbell cable and the like and such cables are connected to the distribution board 11.

The DIN bar multi-switch will be installed in the distribution board 11 and power cables to appliances will be connected to the power terminals of the multi-switch outputs. The shared three-wire cable serving as a parallel interconnection of all wall-mounted controllers 10 will be extended to the multi-switch and connected to the control terminals—see the FIG. 1.

However, if the distribution board 11 is far away from the appliances and the power supplying cables to individual appliances would be too long, the box multi-switch model is to be used. It will be installed immediately below one wall-mounted controller 10. This design envisages the same interconnection of the wall-mounted controllers 10 but only a 12-24 V feeding cable will be provided to the wall-mounted controller 10 with the multi-switch from the distribution board 10. A thin and relatively inexpensive low voltage wires Sykfy UTP, doorbell wires are provided to individual appliances from the controller 10 with the multi-switch. On/off switching elements—relays, opto-elements and the like that will switch the given appliance (see the FIG. 2) will be installed in appliances that may be connected to a single power cable circuit.

When controlling the system, one short stroke of the left-hand pushbutton will turn up the ceiling mounted lighting fitting 12̂ activate the output I. The ceiling-mounted lighting fitting 12 will be turned down in the same way. Two short strokes of the left-hand pushbutton will activate the decorative lighting 14, activate the output II and the same operation has to be used to turn down the decorative lighting 14. A short stroke of the right-hand pushbutton that controls the output IV will switch the reading lamp 13—what is controlled is the socket, and the same stroke will turn down the reading lamp 13.

Two short strokes of the right-hand pushbutton will activate the heating system 16—output V—and the same operation will turn the heating system 16 down. The window shutter 15 is controlled by both pushbuttons as the drive has two controlled directions—up and down—and, moreover, the activation outputs just not remain switched after the activation as it was in the previous cases of the lights 12, 13 and heating system 16. That means that it is necessary to carry out a short stroke of both pushbuttons at the same time. This operation will switch the system from the switching mode over to the controller mode which means that the outputs III and VI will be active only as long as the right-hand or left-hand push button or both of them are pressed down and it will provide for a comfortable setting of the widow shutter 15 or roller to a desired position. However, the system does not need to be brought back to the lighting/heating system switch mode as it will be done automatically after the end of the control of the drive of the shutter 15 or roller.

This is the way the system may be used in the option 2. The total number of system setting options is six. The option is to be chosen when installing the system depending on the appliances that have to be controlled. Thereafter, the appliances will be connected and no other steps are needed.

### INDUSTRIAL APPLICABILITY

The single-rom electrical appliance multi-switch as described in this patent paper may be used in family houses, apartments, accommodation facilities, office buildings, vessels and the like wherever the standard installation starts to be too complex, costly a non-aesthetic.

1. A single-room electrical appliance multi-switch system using a single-wall mounted controller characterized by being provided with a programmable multi-switch that may switch at least 3 output circuits and/or appliances controlled by at least one wall-mounted controller consisting of at least a basic single-pushbutton control element with the configuration of pushbuttons 1/0 interconnected with performance switching elements for the switching of power circuits.

2. The system as described in claim 1 wherein the wall-mounted controller has a basic double pushbutton with the configuration 1/0+1/0 with the possibility of switching of at least 6 outlets and/or appliances.

3. The system as described in claim 1 wherein individual switching circuits may be set to the mode of a bistable switch and/or as up to four time switches and/or as a single time switch dependent on another output.

4. The system as described in claim 1 wherein it is modified for the control of the multi-switch by a short stroke or double stroke or a longer stroke.

5. The system as described in any of claim 1 wherein it is located in an installation box below the machine of the wall-mounted controller and of being interconnected with the distribution board by feeding cables 12 to 24 VDC with low voltage feeding cables being brought to individual appliances whereby the appliances are provided with performance switching elements for the activation of the given appliance.

6. The system as described in any of claim 1 wherein the source of power supply, switching elements and the system itself are integrated to a single box and installed in the distribution board.

7. The system as described in claim 5 wherein the performance switching elements consists of relays or opto-couplers.
